(19) United States
(12) Patent Application Publication
(10) Pub. No.: US 2023/0394497 A1
(43) Pub. Date: Dec. 7, 2023

(54) Automatic Normalization for Service Level Agreement Monitoring and Conformance Engine

(71) Applicant: Tangoe US, Inc., Stamford, CT (US)

(72) Inventors: Dale L. Clark, Mukilteo, WA (US); Jaan Leemet, Aventura, FL (US)

(21) Appl. No.: 18/324,076

(22) Filed: May 25, 2023

Related U.S. Application Data
(60) Provisional application No. 63/349,806, filed on Jun. 7, 2022.

(51) Int. Cl. G06Q 30/018

(52) U.S. Cl. CPC G06Q 30/018

(57) ABSTRACT

A system and method incorporating a Service Level Agreement (SLA) monitoring and adherence methodology using trigger events from both internal systems and third-party systems to provide auditable SLA compliance metrics.

### FIELD OF THE INVENTION

The present invention relates to systems and methods for analyzing and ensuring adherence to service level agreements in telecom expense management applications whereby auditable events are tracked and measured to confirm adherence and a set of standardized parameters are provided for third parties to interact with the system. Disparate data is aggregated to provide a normalized definition of SLA conformance.

### BACKGROUND OF THE INVENTION

Service Level Agreements (SLAs) in the telecom industry are often used to define how a provider agrees to provide contracted services within a given timeframe and with a given quality from when requests are received (e.g., a person orders a new mobile phone with a certain configuration to be delivered to the person within a certain timeframe). SLAs can also exist in other industries, for example IT services or other arrangements where time based performance and delivery is required.

The ability to meet and adhere to an SLA is often a huge competitive advantage for a provider as it can put the customers mind at ease in terms of how long requests may take, and how long they may be without functionality. The use of credits or penalties is one way a contracting party can encourage the provider to adhere to the SLA terms.

In broad terms, the service level that is to be monitored can be something as simple as how often a system is available for customers to access, or it could be more complex such as monitoring the quality of a service provided using parameters such as bandwidth and signal quality. In one example, a procurement portal may be monitored where customers place orders for a telecom device. It is not uncommon for these portals to require periodic maintenance for either upgrades or enhancements. An SLA in this case may be structured in a way that the system will be available 99.9 percent of the time 24/7/365 (24 hours a day, 7 days a week, and 365 days a year).

Such an SLA would allow for up to 8.76 hours a year for planned maintenance. These maintenance windows would most likely have to be negotiated in advance to coincide when the system is not busy and allow for warning of customers in advance of when maintenance and downtime may occur.

Extended outages may occur as a result of maintenance taking longer than expected due to unforeseen events. Unplanned outages may occur when the system goes down due to bugs, attacks, overloading, power outages or hardware failures. Outages may also be planned but be undertaken immediately to address security threats, software bugs or imminent hardware failures. Many of these situations may be covered by the parameters of an SLA, and in these cases, detection and resolution plans must be in place to mitigate the outages to avoid breaching the SLA windows and timelines. Stipulations with regard to reporting the outages are often part of the negotiation of the SLA.

If a system vulnerability is detected or a new security threat announced, the risk of problems from failing to address the issue can be serious. Contractual clauses to call out such immediate threats as unforeseen but no fault of the provider, may allow for special cases and may be excluded from the SLA.

Further, many service providers have redundant systems, which serve as backups, allowing a switch-over to occur if an outage is detected without any disruption to services. In such cases, the events do not impact the SLA. These redundant system switchovers can also be used for periodic planned maintenance allowing for more maintenance windows without having to negatively impact the SLA.

Failure to meet requirements outlined in an SLA may result in penalties in the form of service credits, discounts, or even fines. Further, failure to meet SLA requirements can reflect badly on the provider in question and may even result in loss or cancellation of the contract if not properly remediated or explained. Loss of good will is very difficult to recapture. Failure to address an issue at hand can also have an escalating impact based on time over the negotiated allowable window contained in the SLA terms. To exasperate matters, some clients may have SLAs for multiple systems in place with a vendor. For example, there may be an SLA for placing orders, another for handling trouble tickets, and yet another for responding to help-desk phone calls. Even if trouble tickets and order placement is working well, if the help-desk SLA is going badly this can reflect poorly on the overall relationship. Combining the data or providing a holistic view of the relationship is difficult to do when the SLAs are measures differently. One goal of the system is to provide a consistent method of assessing SLA performance regardless of the details behind conformance as they relate to specifics of the system. Such a customer, with three SLAs should have an overall SLA conformance score to measure and assess the relationship. In cases where some systems may be less critical, weights can be appropriately assigned.

The issue of conformance to an SLA raises the question of how performance is measured. For instance, there could be edge cases or exceptions that may result in failure to meet the terms of an SLA, or for a customer to perceive that this is the case. Both of these instances are problematic for the service provider in terms of customer satisfaction. It is often difficult to measure and justify these edge cases or to explain them. Even when edge cases are explained, customers may not fully understand the issues or take the time to listen. For example, when an executive expects their new phone before their business trip, they do not really care about the logistical details of why it was not delivered, only that they didn't receive it when they needed it.

Regardless, it's important to define and measure in a consistent way events that contribute to the SLA and which may affect it. When looking at systems from third parties, there may be a different set of events that are generated for the same process making it difficult to assess the process or predict outcomes that can lead to SLA related issues. In some cases, the events may be virtually identical but mean different things because of the way internal processes are defined and executed. A system to normalize these events and to define a flexible definition for these processes is necessary to accurately track the states that form a part of the SLA and how the events from outside systems map to these states.

Take for example, and SLA for a procurement system. The SLA may be structured in a way as to ensure a customer receives service within a given timeframe when they initiate an action. This can be as simple as having someone answer the phone within a specified number of rings, seconds or minutes, or having a new device delivered within a given timeframe. Different systems may report this data differently. A common occurrence is the reporting of a completed order when it is shipped. However, some systems may consider the first step in shipping simply the creation of the shipping label, which can be generated well before the package is closed or delivered to the courier for delivery. The definitions and the events that cause transitions from one state to the next must be understood and in some cases interpreted or adjusted between two vendors or systems to map to a given normalized SLA process to ensure that time in the appropriate states is properly tracked.

In the case of delivering a device, when placing the order, the customer may fail to fill out the procurement order properly, which may result in delays that are unrelated to the responsiveness of the provider. For example, if a color was not selected, or a backup color in the case of a given color not being available, was not specified, the provider may be required to request clarification from the customer. Here, the customer may not be immediately reachable and servicing the request may be delayed even if the provider is available and ready to do so. This delay in fulfilling the request is not the fault of the provider and the provider should not be penalized for any delay caused by the customer failing to provide the needed information.

In another case, if the customer makes a typo on the delivery address and the device is returned to sender, then the correct address must be obtained before the device could be resent. Even if the device was mailed out in time, it would not reach the customer in the expected timeline, but again, not due to any fault directly attributable to the provider.

In such cases, it is not correct to say that the provider has “failed” to meet the terms of the SLA even though the procurement event took longer than specified in the SLA.

In some cases, the provider may also be reliant on third party systems, such as an equipment manufacturer, a shipper, or a parts supplier, packer and so on, in order to meet the requirements outlined in the SLA. In recent years, the difficulties in global manufacturing and shipping have caused unexpected and incurable delays in obtaining certain types of products, such as, microchips and the like. In such cases, the provider should also have in place a system by which these vendors are also under the SLA and that the component parts of the SLA that it offers considers these third-party SLAs comprising sub-steps to the steps required to complete the negotiated actions that are covered under the SLA. This approach, however, creates the challenge of measuring against SLA requirements with data received from potentially very different systems that may describe virtually identical events in different terms or measure events differently.

A more appropriate process may be to itemize the time spent to address each step of the process that was under the providers control, and to pause the SLA clock when the provider is waiting for feedback or clarification. If incorrect data was entered, perhaps the fulfillment based on the given information should be measured with rework due to change being outside of the scope or be treated as a separate transaction.

Regardless, the perception of the customer is sometimes such that whether or not they played a part in delaying an order, the vendor should deliver as per the terms in the SLA. Moreover, if the customer were to complain to their management that the provider was not fulfilling their SLA requirements, it would be incumbent on the provider to defensibly show the steps and exceptions in such cases to change the perception and avoid payment of penalties.

Such an effort may involve auditing the system to get the details of a particular transaction, which in practice is quite time consuming. The audit may, in fact, be more costly than simply paying the penalties.

While one approach is to assume the customer is always right and therefore simply paying the penalty outlined in the SLA is good business sense, it could be perceived as admitting the provider failed to adhere to the SLA requirements. This, in turn could negatively impact the provider when the time comes to renew the contract. As such, while it may be easier and even more cost effective to simply pay penalties, the reputational harm to the provider could be large. A perceived “failure” to live up to the terms of the SLA and the resultant loss of good will with the customer may be very costly.

U.S. Pat. No. 10,572,650 (Cooper) teaches a method of monitoring SLA conformance via a set of SLAS (Service Level Agreement) Agents. It requires running customized SLA agents, which is not possible on third-party systems. Third-party systems often have specific data formats and descriptions of items that differ from descriptions of an identical item in another system. Different descriptions can make it virtually impossible to measure timeframes or make comparisons consistently across multiple divergent systems. This is especially true if one considers that the same client may have multiple SLAs with a vendor for different systems.

U.S. Patent Publication 2019/0253558 (Haukioja) teaches methods of SLA adherence based on feedback of customers and customer perceptions, but it does not allow for a systematic set of SLAS affecting triggers to turn on and off an SLA clock, which would accumulate time towards SLA compliance for a given event. Likewise, Haukioja like the Cooper reference noted above, fails to teach a system that can systematically compare data across multiple divergent systems.

It would thus be very beneficial to have a system that can adapt to dynamic changes in a process required to fulfill an SLA across multiple systems. In one instance, it would be beneficial to have the ability to allow for an SLA clock to cycle on and off when the steps involved are in the control of the provider or one of its providers to allow each of the service providers to provide SLA triggers for their own events. This would allow for measurement and mapping of these steps to normalized states as defined by an SLA engine. The data of such a system could be used to trigger early warnings of potential SLA breach, for continual improvement, and for auditing and providing documented proof of SLA conformance.

It would further be beneficial to have a system that would allow for automatic cross-comparison of data with third-party systems where each of the systems includes data that may be formatted distinctly and described uniquely. The mapping of these outside events into a flexible process definition capable of mapping a variety of vendor specific events into normalized SLA related states is paramount to properly measuring and adhering to SLAs in a consistent fashion. It is also important for auditing functions to show customers in a systematic way that the provider has conformed to an SLA even if a timeframe was not adhered to in an SLA.

It would still further be beneficial to have a system that would normalize the SLA data from disparate systems that may be provided for the same client so as to have a consistent and holistic view of an SLA with a given client. The combination or aggregation of the SLA data across various systems can be used to provide an SLA health for a given client with one or more systems. This evaluation may take into account weights to skew customer satisfaction based on the importance or visibility of systems within the customer.

Therefore, a need exists for a system and method to measure and monitor a service providers ability to adhere to an SLA that includes SLAs from its vendors that aggregates and normalizes SLA data from diverse sources so it can be uniformly presented across different data types and processes.

### SUMMARY OF THE INVENTION

Accordingly, it is desired to provide a system and method that is able to measure SLA conformance for a vendor providing services, which must adhere to an SLA.

It is also desired to provide a system and method that is able to take inputs from third-party systems that provide services relating to the fulfillment of the service described in the SLA, such that these inputs can be used to automatically analyze SLA compliance of such vendors even if such vendors use a diverse set of data formats and/or describe identical data and information in unique ways.

It is further desired to provide a system and method that processes data from disparate systems in a uniform fashion for analyzing customer satisfaction.

It is further desired to provide a system that works with events and states within the SLA that can track events that cause transitions between said states.

It is further desired to provide a system and method that generates automatic detailed audit reporting of SLA activities whereby SLAs clocks are counting that can be used as audit logs or proof of SLA adherence.

It is still further desired to provide a system and method that facilitates adding services to the SLA engine via a standard set of SLA events and steps.

It is yet further desired to provide a system and method that utilizes machine learning to generate early warning of potential SLA breach events to allow for escalation and optimization of processes to improve SLA adherence.

Finally, it is desired to provide a system and method that eliminates the need for manual intervention to look through audit logs and paper trails to match events with SLA adherence when responding to reports of failed SLA conformance. The system is adapted to automatically generate and transmit a detailed and clear set of timed steps to confirm whether an SLA was adhered to.

In one configuration, an SLA system is provided that includes a computer having software executing thereon where the software comprises an SLA engine that receives as inputs, SLA triggering events. These SLA triggering events include, but are not limited to, procurement orders, invoice receipts, requests for service, accessory orders, repair orders, and the like.

The SLA system is adapted to automatically capture events from external systems, such as, the entry of a procurement order. This automatic capture could occur through an RPA bot that pulls data from an order processing system, or through an API call. In any such case, when data relating to a procurement order is received by the system, this triggers the start of an SLA event.

One problem the SLA system must overcome is that third-party systems do not have a standard way of describing certain items and/or events. This means that different terms are often used to describe virtually identical events from one third-party system to another. The SLA system then is faced with trying to connect seemingly incoherent data to establish one coherent system. Additionally, not only are different terms used to describe virtually identical items and/or events, but different data formats may also be used by the various third-party systems. This provides a serious software challenge to fully automate the entire SLA system.

Continuing with the example of a procurement order, an initial step would be the determination of whether the order was complete. Any missing information would turn off the SLA clock and automatically send a request to the ordering system to complete the procurement details. Using the same example of specifying a color for a phone, if the user was ordering a new iPhone®, and failed to specify the color, the order could be rejected and a request for clarification sent to the user before resuming the SLA affecting activities.

In the case above, even if the color was specified, inventories are dynamic and even if the user specified a particular color, it is possible that when attempting to fulfill the order, the system is notified that the selected color is on backorder. In such a case, the system may have requested a backup color selection, or the system may simply kick back the procurement order to the customer asking them whether they prefer a new color or desire to wait through the backorder period. In both cases, the SLA clock should automatically stop awaiting a response from the customer. In the latter case, it could be decided to take the transaction out of the standard SLA transaction path, whereby the new transaction is not applicable to the SLA as we have opted to wait on a back-order device, which is out of the control of the service provider.

A procurement order that comprises steps requiring the fulfillment from a third-party would also include sub steps performed by the third-party. In such a case, the system can monitor and capture events which allow for tracking the SLA in place with the third-party.

For example, in a procurement scenario, if the device manufacturer received orders directly, it may have a series of finite steps such as (a) Order Received (b) Order Validated and Accepted (c) Order Processing (d) Order Packed, (e) Order Shipped. In such cases, the SLA management system can pull through the states as data elements that can be shown to the end user, but it can also hold the supplier accountable to its own SLA for the order. For example, if the SLA with the vendor requires same day shipping, alerts and escalations can take place if this has not been achieved. A quick reaction to these third-party SLA risks will also help the system stay within the overall SLA in place with the end customer.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “process” and “processing” as used herein each mean an action or a series of actions including, for example, but not limited to, the continuous or non-continuous, synchronous or asynchronous, routing of data, modification of data, formatting and/or conversion of data, tagging or annotation of data, measurement, comparison and/or review of data, and may or may not comprise a program.

In one configuration a system for gathering SLA events is provided, the system comprising a computer having a storage and a network connection and software executing on the computer comprising an SLA engine automatically capturing and recording events as they occur, the SLA using RPA bots having site access credential information to obtain relevant data events from the systems involved.

In another configuration, a method for obtaining SLA data accessed from a provider site by an RPA bot is provided, the method comprising the steps of contacting the site with an RPA bot executing on a computer via a network connection, presenting site access credential information to the site with the RPA bot, which when authenticated enables the RPA bot to access and retrieve data from the site, and accessing events and steps in a process required to fulfil a subpart of the SLA affecting event being addressed by the third-party system.

In either case, the normalization of data is key to the automatic nature of the SLA system to be able to gather and compare data. In one configuration, a database or look up table of data is provided where diverse information can be normalized allowing the SLA system to automatically compare similar or virtually identical data that may be referred to by diverse names. Once data is identified and grouped according to the SLA system, in one configuration data can be appended to a file to associate it with commonly used terms by the SLA system. There are many ways this can be accomplished, such as, for example, appending information to the meta data of a file and so on. Likewise, data received in various formats may be identified and automatically converted into file formats used by the SLA system allowing for a fully automated and integrated system.

In one aspect a system for tracking telecommunications Service Level Agreement (SLA) compliance is provided and includes a computer having a storage and a network connection and software executing on the computer comprising an SLA engine. The SLA engine receives indication of an order selected from the group consisting of: a telecommunications service, a telecommunications device order, technical support, shipping or combinations thereof. The SLA engine further accesses one or more external systems which process the order, the one or more external systems accessed using the network, and the SLA engine identifies one or more events associated with the order based on data accessed at the one or more external systems, wherein the SLA engine obtains data concerning those one or more events from the one or more external systems and converts said data to a standardized format and stores the data in the standardized format in the storage. The SLA engine further determines a maximum time for the order associated with the SLA and further determining from the one or more events when to start and stop a timer such that the timer tracks compliance with the maximum time required by the SLA associated with the order such that the SLA engine automatically starts and stops the timer, wherein the timer is stopped when the one or more events indicate the order is waiting on information from one or more users and the timer is started when the information from the one or more users is received. The SLA engine generates an audit log from the data in the standardized format, the audit log indicating one or more reasons the timer stopped or started, the one or more reasons determined based on the one or more events.

In certain aspects the audit log indicates one or more reasons for each time the timer stopped and started. In other aspects the SLA engine further generates a communication for transmission to the user when the timer is stopped, the communication requesting the information the user, the audit log includes at least a portion of the communication. In still other aspects, based on an amount of time remaining in the timer as compared to an expected amount of time to complete the order and alert is generated by the SLA engine if the comparison indicates a possibility of non-compliance with the SLA. In still other aspects the SLA engine determines from multiple previous orders an expected amount of time for one or more stages of the order and based on actual time for the one or more stages of the order, the storage is updated such that an expected amount of time for one or more stages of a future order is determined based on the multiple previous orders and the order. In yet other aspects, based on an amount of time remaining in the timer as compared to the expected amount of time to for one or more stages of the order an alert is generated by the SLA engine if the comparison indicates a possibility of non-compliance with the SLA.

In another aspect a system is provided for avoiding Service Level Agreement (SLA) penalties and includes a computer having a storage and a network connection and software executing on the computer comprising an SLA engine. The SLA engine receives indication of an order selected from the group consisting of: a telecommunications service, a telecommunications device order, technical support, shipping or combinations thereof. The SLA engine monitors a timer set based on an amount of time to complete the order according to the SLA engine. The SLA engine further tracks an amount of time remaining in the timer as compared to an amount of time that is expected to remain until completion of the order and if the comparison exceeds a threshold, the SLA engine generates an alert indicative of a SLA penalty or possibility thereof. The SLA engine further determines an actual time to complete the one or more stages of the order and updates the storage with the actual time for the one or more stages such that the SLA engine is trained based on the actual time.

In certain aspects the SLA engine is trained to determine the amount of time that is expected to remain for future orders based on the actual time of one or more past orders. In other aspects the actual time of one or more past orders is an amount of time to complete one or more stages of that order. In still other aspects the SLA engine further accessing one or more external systems which process the order, the one or more external systems accessed using the network, and the SLA engine identifies one or more events associated with the order based on data accessed at the one or more external systems, wherein the SLA engine obtains data concerning those one or more events from the one or more external systems and converts said data to a standardized format and stores the data in the standardized format in the storage. In yet other aspects the amount of time to complete the order is a maximum time for the order associated with the SLA and the SLA engine further determining from the one or more events when to start and stop the timer such that the timer tracks compliance with the maximum time required by the SLA associated with the order such that the SLA engine automatically starts and stops the timer, wherein the timer is stopped when the one or more events indicate the order is waiting on information from one or more users and the timer is started when the information from the one or more users is received. In yet other aspects the SLA engine generates an audit log from the data in the standardized format, the audit log indicating one or more reasons the timer stopped or started, the one or more reasons determined based on the one or more events. In certain aspects the audit log indicates one or more reasons for each time the timer stopped and started.

In other aspects a system is provided for avoiding Service Level Agreement (SLA) penalties and includes a computer having a storage and a network connection and software executing on the computer comprising an SLA engine. The SLA engine receives indication of an order selected from the group consisting of: a telecommunications service, a telecommunications device order, technical support, shipping or combinations thereof. The SLA engine monitors a timer set based on an amount of time to complete the order according to the SLA. The SLA engine further determines one or more stages for the order and determines an expected amount of time for completion of each of the one or more stages based on order time history data stored in a storage accessible to the SLA engine. The SLA engine additionally tracks an amount of time remaining in the timer as compared to an amount of time that is expected to remain until completion of the order based on the expected time for each of the one or more stages and if the comparison exceeds a threshold, the SLA engine generates an alert indicative of a SLA penalty or possibility thereof. The SLA engine also determines an actual time to complete the one or more stages of the order and updates the storage with the actual time for the one or more stages such that the SLA engine is trained based on the actual time.

In certain aspects the SLA engine further accessing one or more external systems which process the order, the one or more external systems accessed using the network, and the SLA engine identifies one or more events associated with the order based on data accessed at the one or more external systems, wherein the SLA engine obtains data concerning those one or more events from the one or more external systems and converts said data to a standardized format and stores the data in the standardized format in the storage. In other aspects the amount of time to complete the order is a maximum time for the order associated with the SLA and the SLA engine further determining from the one or more events when to start and stop the timer such that the timer tracks compliance with the maximum time required by the SLA associated with the order such that the SLA engine automatically starts and stops the timer, wherein the timer is stopped when the one or more events indicate the order is waiting on information from one or more users and the timer is started when the information from the one or more users is received. In still other aspects the SLA engine generates an audit log from the data in the standardized format, the audit log indicating one or more reasons the timer stopped or started, the one or more reasons determined based on the one or more events. In yet other aspects the audit log indicates one or more reasons for each time the timer stopped and started. In still other aspects the SLA engine modifies the order at one or more external systems based on the alert to shorten an expected time for a next stage of the order.

Other objects of the invention and its features and advantages will become more apparent from consideration of the following drawings and accompanying detailed description.

### BRIEF DESCRIPTION OF THE DRAWINGS

FIG. 1A is a functional flow diagram according to the present system.

FIG. 1B shows a process implemented in FIG. 1B.

FIG. 2 is a functional flow diagram illustrating an SLA affecting Event.

FIG. 3 is a functional flow diagram illustrating third party system interactions with the system.

FIG. 4 is a functional flow diagram illustrating how the system automatically provides early warning indicators.

FIG. 5 is a process diagram illustrating how the system can provide for continual improvement via machine learning.

FIG. 6 is a process diagram illustrating how the system can provide for dispute resolution with an SLA event.

FIG. 7. is a process diagram illustrating how the system can provide for normalization of two outside systems with internal processes and events and how they are mapped into states.

FIG. 8 is a process diagram illustrating aggregation and normalization of order processing and ticket management information.

### DETAILED DESCRIPTION OF THE INVENTION

Referring now to the drawings, wherein like reference numerals designate corresponding structure throughout the views.

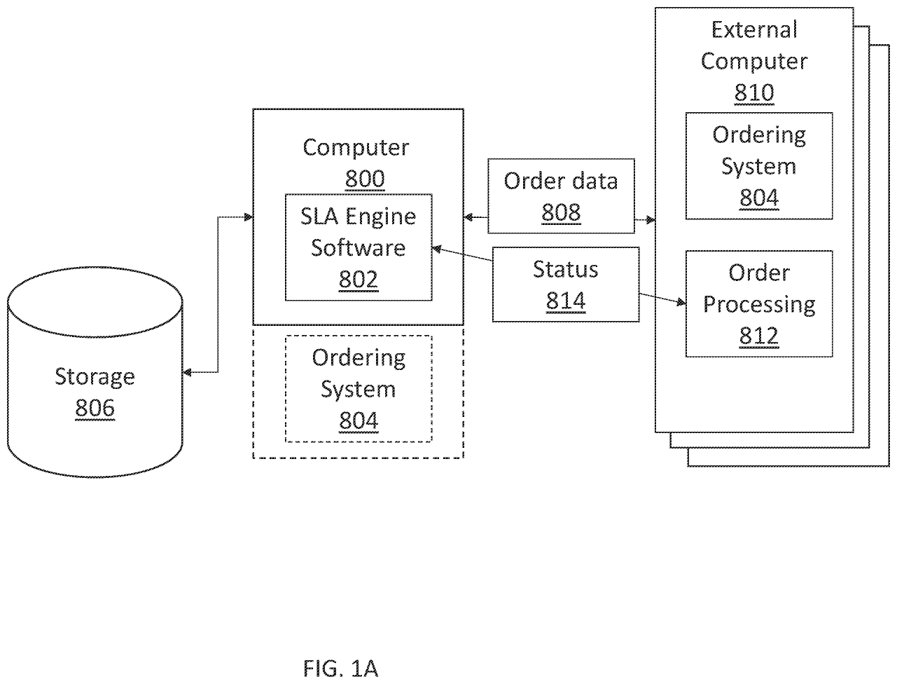

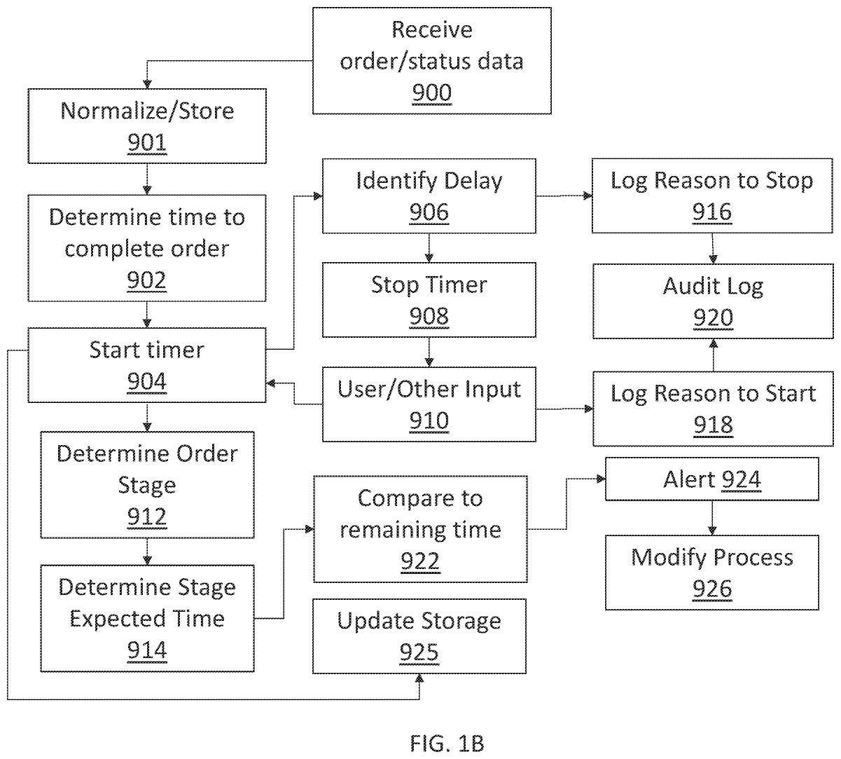

FIG. 1A shows the computer 800 with the SLA engine software 802 executing thereon. The computer may provide an ordering system 804 which may transmit an order to one or more external computers 810. Alternately, the ordering system 804 may be provided at the external computer. In either case, order data 808 is exchanged to between the computer 800 and the external computer(s) 810 to possibly submit the order and also to determine when orders are made and for submission of additional data as needed. The order processing feature 812 of the external computer refers to the tracking system for the various stages of the order. The external computer may be, for example the carrier, the device supplier, the shipping company or a variety of other entities that have touch points within the order process. Each system will have a way to monitor the component of the order processing 812 that this entity is responsible for. Thus, the status data 814 can be obtained for the SLA engine software 802 to track the progress of the order. This status data and associated timeframes to complete the various stages of the order is stored in the storage 806.

Referring to FIG. 1B, an example process for the SLA engine is shown. The order and/or status data is received 900 at the SLA engine 802 and this data is normalized and stored 901 in the storage 806. Since the data from the external computers 810 is typically stored in a different format for each external system, merely saving the data does not automatically make it useful in that the data may be there, but the SLA engine 802 cannot utilize it unless the data is transposed and normalized into a consistent and unified format so that data from the multiple systems can be monitored and used. With the order/status data 900 in, the SLA engine determines an amount of time available to complete the order 902. This amount of time is normally set by the Service Level Agreement which might specify a turnaround time between a new/replacement device order and the delivery thereof to a user. Here, the SLA may have penalties for failure to adhere to timely delivery of devices and/or services, thus the time available must be known and then the time clock is started 904. In some cases, there may be a delay 906 and it is important to identify if that delay is one that is responsibility of the provider or the customer. For example, if the customer ordered a device not in stock, the ordering system would need to alert that user and wait for a response to choose e.g. a different device/color or otherwise respond to the request for more information. If the user does not respond in a timely manner, this would be an example of a delay that is not the responsibility of the provider and that the provider cannot be held responsible for under the SLA and the timer would stop 908. In the same example, once the customer provides input 910 such as a different color or device, the timer starts again 904. A similar process is used for e.g. IT helpdesk scenarios where the IT professional needs input from the user/customer and while waiting for a response, the provider of IT services is not responsible for the delay and thus the timer can be stopped. These are but some examples of situations where a service agreement (SLA) may specify time periods for particular tasks and completion/resolution thereof that the SLA engine needs to track and ensure compliance with.

However, merely tracking the time is often not enough as there needs to be a verifiable process to determine compliance with the SLA. Particularly, if there are complaints about a request not being processed in a timely manner where the customer believes e.g. that the device was delivered too slow or otherwise that the SLA was not complied with, the process of understanding the reasons why time between order and completion may appear outside the required time but actually comply with the SLA is challenging to understand and explain. More specifically, if there are justified delays in an order processing because the customer did not provide all required information, even if this is true, it is important to be able to show that the SLA was complied with and that the delays were the result of e.g. the customer not properly submitting their order or failing to respond to a request for information. Thus, In the process of starting/stopping the timer, the reasons for starting and stopping are logged 916/918 and are added to an audit log 920. The audit log 920 for each order can specify reasons for delay in some embodiments, the log 920 can further specify how those delays were identified 906 in a manner that references e.g. the SLA. The Audit log can also reference as exhibits or clickable links the communications between the provider and customer/user related to the order or otherwise obtain excerpts/timestamps or other information from the related communications or requests where a delay was identified 906. It is similarly important that reasons and data surrounding when and why the time was re-started after a stop 908 to show that the timer ran when it was supposed to. When the order has been submitted but not completed, it can go through various stages, each can have its own expected time to completion. Thus, as the order is waiting to be completed the stage is determined 912 and expected time 914 determined. The overall order timer may not be the only timer the SLA engine keeps track of as the individual stages may be associated with their own timers to monitor. If there is a delay in one stage of the order that does not allow for stopping 908 the timer and alert 924 may be issued and, that order process may be modified 926 to prioritize the order at the next stage. For example, if there is a fulfillment delay that means the ship speed will result in non-compliance with the SLA for the order, the SLA engine may communicate with the external shipping system to change shipping speed to be expedited. In this manner, although one stage of the order took longer than it should have, overall SLA compliance is maintained by the SLA engine stepping in and revising something about the order to catch up. This can apply for other situations where, e.g. a particular order is brought up earlier in the queue of tasks at a next stage of the order in order to catch up. It is understood that the timer starting and stopping may be a series of time stamped events that allow for keeping track of the time remaining/elapsed such that an actual timer is not running. However, an actual timer could also run in order to track compliance with SLA requirements. The audit log 920 can further include the time stamps of the various events/reasons which caused the timer to start and stop. Furthermore, the storage 806 is updated 925 based on the timer, specifically the amount of time it takes to complete the order or the various stages thereof. Updating the storage can cause the SLA better determine the expected stage time 914 with better accuracy. For example, if the same stage typically takes a defined amount of time that is regularly predictable, departure from that time may merely adjust the average time. The average time may be computed instead based on the most recent timeframes selected as most representative. However, there is a risk that if there is a delay for a short period of time and only those timeframes are used, the process may be modified to choose faster shipping to ensure compliance, which increases cost. Thus a comparison to historical timeframes can be made after a modification to the process is made to ensure the lower cost option is selected if that is expected to provide adequate order stage completion according to the SLA.

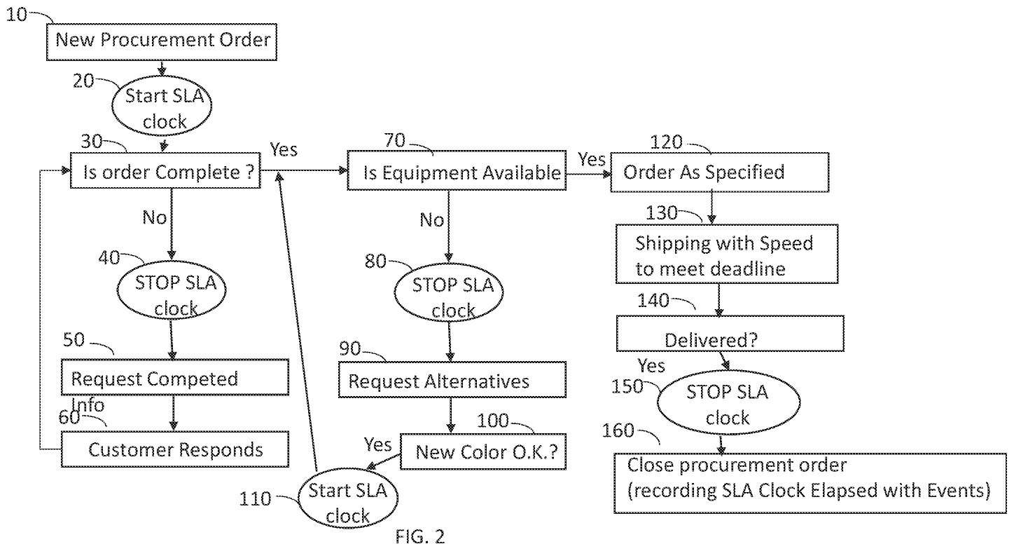

Referring to FIG. 2 the flow of a simple SLA affecting event is illustrated. A new procurement order (10) is generated and received by the system, which causes the SLA clock to start (20). At this point, all elapsed time is counted towards the SLA.

An initial step is to check the completeness of the procurement order information (30). This ensures that all relevant data is entered, and that the procurement order can be fulfilled. If information is missing or not accurate/conflicting, (40) the SLA clock is stopped as the order cannot be advanced due to circumstances outside of the normal flow. A customer request for clarification is created (50) and the system will wait for the customer response (60). During this time the SLA clock would not be running.

Once the customer responds (60), the system checks to see if the new information entered provides a complete order that can be processed. If there are still items missing, the same flow (40,50,60) is followed. If the information is now correct and complete, the system automatically starts the SLA clock (20) and moves on to the next step of checking if the equipment is available (70). While some systems may provide dynamic inventory and not allow orders to be placed (10) if inventory is not available, these levels are often moving so quickly that this approach is not possible. Especially when ordering from outside third-party systems where others may also be competing for the same inventory.

If the check for equipment availability (70) shows that the ordered device or components are not available, the SLA clock automatically stops (80) again, and the system will prompt the user for alternatives (90). For example, if a chosen color is not available, the system may ask if another color would be acceptable (100). If yes, the SLA clock is started again (110), and the remainder of the order is checked component and component. In some cases, this may entail going back to check the order (30) as compatibility between components in the order may also need to be checked if for example a different size is selected. In such a case, accessories may no longer be compatible, and the order may need to be changed. Note also that if the customer decides to wait for the initial color, the SLA clock remains stopped (80) until the equipment arrives and then will automatically start (20) again.

If the order equipment is deemed available (120) the order is processed for shipping (130) and the delivery notification (140) is received at which time the SLA clock is stopped (150) and the order deemed fulfilled (160). The individual elapsed time for when the SLA clock was running is tabulated in the system as the total time for the order for events that were under the service providers control. The times when the SLA clock was not running are not added to the SLA time total but the overall elapsed time such as when the order was placed and when it was competed is kept by the system for reference. The various start times of the SLA clock are also saved allowing the system to gather and show delays such as how long the delay was to get the order entered accurately (40) and how long the system had to wait for equipment availability (80). While this example is simplified, the same processes and SLA steps can be included in a much more complex process. As another example consider manufacturing and assembly steps, each of which may have a start and a stop with dependencies for part, labor and machines or tools. At each step the SLA clock may be stopped if it was desired to measure the time for each step within the provider's control. Of course, the end customer who has the SLA with a service provider may draw the line at whether or not the SLA can be changed due to internal service provider issues (such as illness, strikes, even material sourcing issues). The supplier is expected to handle it's sourcing and keep its inventory on hand and have laborers and machines and so on available. The constraints are generally specified in the SLA itself as allowable exceptions.

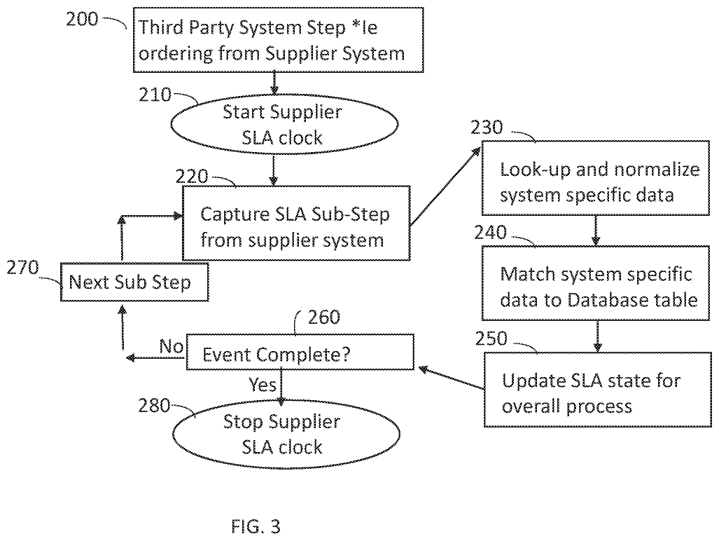

FIG. 3 illustrates how the system interacts with third-party systems. While this is a short snapshot of a sub-step, which is a step in the supplier's process considered a sub-step for the overall SLA process.

A third-party system (200) may be responsible for a sub step of the overall SLA monitored process, such as the delivery of a part or component necessary for completing the SLA based activities. In such a case, the vendor can be monitored with an SLA, which is an integral part of performing within the overall NDA. To measure the supplier tasks, a separate suppler SLA clock (210) may be used that is similar to the overall SLA clock described in FIG. 2. The supplier SLA clock is started (210) when the tasks requiring third-party involvement is started. The supplier sub-system is responsible for providing necessary status information as per the system requirements. This is captured by the system (220) for each sub step.

The tasks (200) may be performed by many vendors where subsystems (220) of each vendor may describe data by different terms and may save data in different formats. A Look-up and normalization (230) process may utilized to match (240) the system specific data into a common format used by the internal system tables and/or databases.

[ono] The normalization process may involve matching key words or actions to coincide with a necessary step in the process. As an example, when the third-party system is intended to deliver a device, the first sub step may be to verify that sufficient data is available to select. This may include descriptive data as well as address data to check taxation requirements. A second sub step may be to check if inventory is available and in warehouses nearby the shipping address.

In each of these cases, there may be normalization required to check the parameters across systems. If devices are ordered from two manufacturers, they may have distinct SKUs to describe the device. Normalization would convert these vendor specific SKUs to an internal device reference number. Some vendors may also provide kits with accessories while others do not, the separation of offerings into individual components may be necessary to normalize the data.

Once normalized, the SLA state (250) is updated, and the system checks to see if one or more sub steps is complete (260). If not, the next sub step (270) is performed and again the status information is gathered (220) and looked up (230) and normalized in order to process it in the SLA engine.

After all sub steps (270) are complete (260) the supplier SLA clock is stopped (280) and the information is logged by the system for tracking and accountability. If the SLA times were exceeded, intervention may be automatically taken to escalate, report and collect penalties or credits where applicable.

External reporting tools can be used to present the information to both operators and customers in the form of reports, dashboards or exported data for consumption by other systems. Operations teams can use these reports to see dynamic real time views of current orders underway with time remaining and any escalations required. The system also automatically generates weekly and monthly reports showing performance against SLAs with a summary of orders and or SLA events.

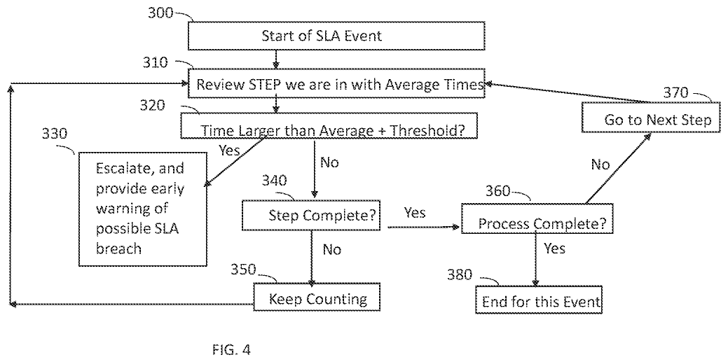

Referring to FIG. 4, the system intervenes to provide early warning indicators to warn of possible SLA breach. Since penalties and credits may be involved, providers want to avoid breaching the SLA and will include escalation methods that can quickly resolve a potential breach. At the start of an SLA event (300), which could comprise a procurement order, the SLA may stipulate that a device must be shipped within a business day. The SLA may also include shipping and stipulate that the device must be delivered within 3 business days. The latter provides more flexibility as it may be cost effective to expedite shipping at a higher cost than to incur penalties.

The system looks at target times based on averages (310) for the steps involved. When configuring the system target times can be entered, which averages (310) reflect actual performance. When major changes occur to the system, such as adding personnel or changing shipping providers for example, the average calculations can be reset with new targets entered.

Once averages have been updated in the system (310) the existing progress on a given step is measured (310) and compared with the average response. If the time is larger than the average plus a set threshold (320) an escalation event (330) is performed that may involve automatically generating an alert, an email to a supervisor, or a red light on a display, and so on. The system is also capable of automatically moving the transactions up in the queue for processing where possible. Even if the step is escalated (330) the SLA clock continues to count up until the step is complete (340), (350). Once complete (360), the next step is measured and monitored (370) again looking at averages with a set threshold. This continues until all steps are complete and the process is complete (360) upon which time the SLA event is complete (380).

Escalation events are also logged in the system to provide input for both machine learning, which may adjust the thresholds and warn of unrealistic SLA goals.

As a real-life example, consider a situation where a customer order is received comprising a phone, a spare charger, and a case. One of the steps in the process would be the “pick and pack” step where a worker goes through the inventory and collects the components putting them in a box and then putting these on a conveyer belt for further processing.

Individual orders may have different SLAs with different customers. For example, an order for an executive of a large customer with a broken phone may be entered as an emergency order with the quickest possible SLA timeline. In such a case, the order for picking and packing would appear on top of the queue, and once packed it would not go on the normal conveyer belt for shipping by may be brought to the front of the line for immediate shipping with priority. A separate pickup may even be scheduled for getting this onto the road as quick as possible.

Similarly, if a pick and pack order following the normal chain of events now gets automatically escalated (330) if time thresholds are passed or escalation events are triggered, the operator doing the picking and packing may see that it is running late and instead of putting it on the normal process for shipping brings it to the front of the line. Likewise, if the provider does not catch the order in time, perhaps the shipper when they get the parcel expedites the shipping or does a special drop-off to get it out faster. This is just one example of escalation and depending on the nature of the SLA sub step, different remedial actions may automatically be taken based on the notification of the SLA system.

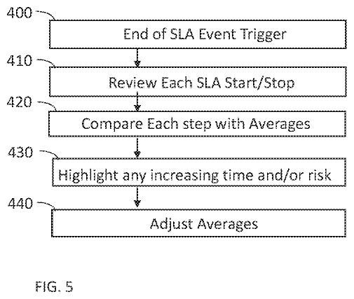

Referring now to FIG. 5, a continual improvement method is illustrated as a process diagram. At the end of an SLA event (400) the individual actions causing the SLA clock to automatically start/stop (410) are looked at and compared to the average times to remediate the situations at hand (420). If the events look to be increasing (430) these are highlighted to expose any potential SLA breach or customer satisfaction issues and averages are adjusted (440) and the system continues to monitor (450) the activities. As one example, the system could be seeing many situations where customers are not filling in a secondary color for a device selection. In these cases, it may be possible to make the secondary color mandatory for the order to proceed and be accepted. Alternatively, for certain orders, language could be included and an affirmation by the customer may be required that confirms the customer accepts the potential of waiting for back-ordered devices that may exceed the normal wait times thereby taking it out of the standard SLA requirements. The system in such cases can automatically notify the customer of the delay should the desired color not be available such that the process does not need to needlessly follow-up with the customer waiting on a response for alternatives or confirmation.

Similarly, if other information is routinely left out of the order process, the forms can be adjusted to make the information mandatory or more check boxes to prompt the user to enter all the data required can be added. Such opportunities for continual improvement are highlighted by the system and will vary depending on where the system identifies that the process stalls (e.g., when the SLA clock is automatically stopped). Additionally, even when the SLA clock is running, the system could report on sub-steps and steps in the SLA processes facilitating identification of where times are increasing, and risk may be increasing. Using the pick and pack procurement process as an example, if the system identifies that pick and pack times are increasing to a point where SLAs may be at risk, the system can recommend that pick and pack personnel be increased, shippers be increased, or even warehouse layouts be improved (e.g., grouping of commonly ordered components).

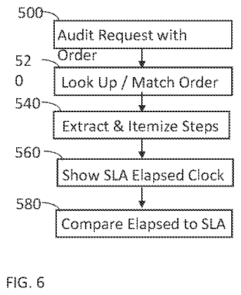

Referring now to FIG. 6, a dispute resolution process is illustrated. As an example, if a customer complains that a process governed by an SLA has not been met, the system can automatically identify and potentially resolve the specific order (500).

The system can then automatically match and look up the order (520) and extract all the itemized steps (540) showing where the SLA clock has been automatically turned on and off and the reasons why the clock was automatically interrupted. These reasons may include: waiting on a customer clarification, waiting on backorder items from a third-party, invalid shipping addresses causing return of items, and so on to name just a few.

When looking that the individual SLA clock intervals and comparing these to the elapsed time (580), it can be seen the SLA clock may show 2 days elapsed where a total of 7 days has actually elapsed. This could be because 5 days elapsed waiting for answers and clarifications from the customer. A frustrated client with the perception that their order is taking too long (e.g., 7 days) can be shown that it was impossible to process the order because information was missing, perhaps when placing orders and that enhanced training of order entry operators may be required or improve systems to make changes requiring certain fields should be listed as mandatory.

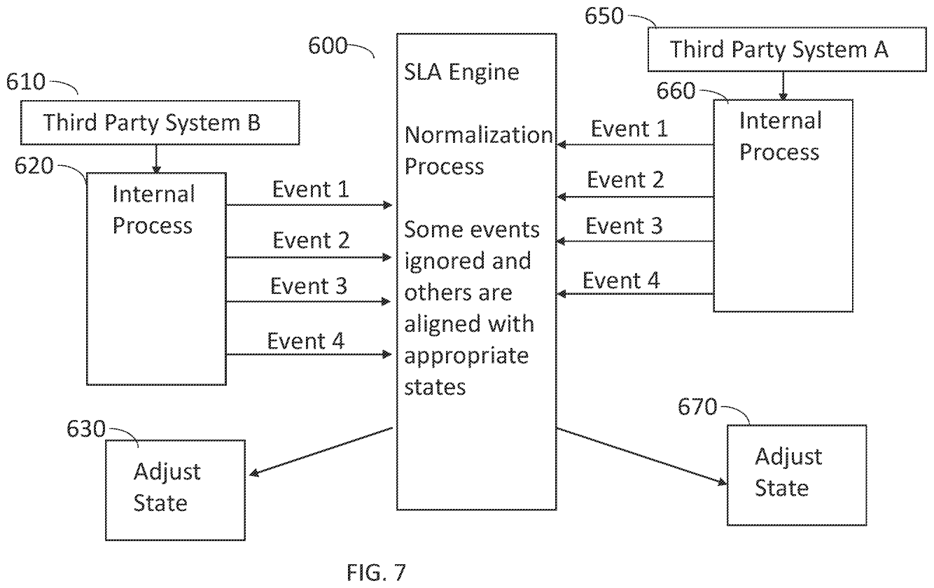

Referring now to FIG. 7 a typical normalization process of activities across two sample third-party systems is illustrated.

Systems (610, 650) are depicted as third-party systems but could very well be internal processes, departments, or functions. In essence, the system generates a set of normalized states (630, 670) for processes and systems that are independent of the specific notifications and events that may occur from the internal processes (660, 620) of independent systems.

Using such a method, the system (600) is able to manage states with the input data that are critical and ignore events that are not. This allows for a flexible definition of a process. Two distinct systems that perform a similar function may have different internal methods to perform that function, and they may report different events or even the same events differently using different parameters or methodology. One invoice processer may read the arrival of invoices with an OCR engine of incoming mail whereas another may wait for a person to open the mail to scan it. The wait time before the invoice starts to be processed may be longer for the scanning of the envelope.

Further, since the system continues to gather all events whether immediately relevant or not, it can employ machine learning to account for these events in the future if they become critical.

As an example, a third-party system (610) is an invoice processing system and there is an SLA in place to manage the invoice process and payment thereof. The system itself has internal processes (620), which generate a number of events that can be exported and read by the SLA engine (600). As a more concrete example, there may be the arrival of the invoice, the parsing of the invoice, the validation and possible approval of the invoice, possible escalation and audit steps depending on the size of the invoice. In such cases, when tracking the SLA, the system may not generate an event for the normal flow of operation but really only if something would cause the state of the SLA timer to change. As an example, if the invoice arrives, the SLA clock may start. For many of the normal event flows, there is no change to the state, and these events can simply be read, possibly timestamped, and recorded, or discarded. However, if an event such as an escalation or a denial of approval occurs requiring manual steps, in some cases it can be deduced that the SLA clock will stop, as there is an exception condition that may be covered by the NDA. In such a case, the system will react to the event received, and adjust the state (630).

Similarly, if a third-party system (650) is managing phone response time, the normal flow of events from the call processing center may involve ringing times, operators picking up calls, and the duration of calls. This data may be correlated with surveys and inputs from customers when they finish their calls. In most cases, the normal flow of events from the system (660) does not change the states of the system. The system would react to a new call coming in (phone starts ringing), for example, as a way to start the SLA timer for response to the event. This is the initial state of the SLA when the clock is started. Once picked up, the call is in progress and the SLA timer for response time can be measured and the ‘answered’ state is entered. Other events during these two intervals are not immediately relevant. The system may however, track operators present, operators available at their desks, and if it is determined that the response time is approaching the threshold of a term defined in the SLA, these events may now become relevant and may be tracked. Reports of operators being absent for prolonged times or not reporting absences (ringing without answering before being redirected) can be tracked and reported on.

The SLA system then, provides for automatically reading events as reported by outside systems, evaluates these events to establish if and how these may map the process into a new state and if the existing state should be changed, and thus account for time spent in that previous state. The system can also help optimize process flows by looking at multiple states that may keep the SLA clock advancing to see how much time is spent in each and where this can be optimized. In effect, this is an important part of the system to be able to predict a potential breach of an SLA before it happens giving the opportunity to avoid the breach before it occurs.

Using the ticket example again, consider a ticket management system (650) and the various events created by the internal processes (660) for ticketing and resolution time SLAs.

If the ticket is created, the event will be one that creates the new SLA process to be tracked and will be the first event to start the SLA clock. Now, as the ticket gets opened, gets assigned, the system knows the typical times it takes to respond and to get a reply to the user. In a case where the ticket is escalated, the system also anticipates that this will add a measure of time for the smaller level two team to open and analyze the ticket. The SLA engine (600) will also anticipate from the number of tickets opened, that there may be a back log and escalations are taking longer. Presumably this buffer time is already built into the SLA.

Taking the exception case where level two does not have enough information to proceed, and a question is sent back to level one. As the ticket bounced back and forth between various internal states in the internal process (660), it does not change the overall state (670) of the SLA. The SLA clock is still advancing, and the state is ‘TICKET OPEN’ and it must be resolved before the SLA time is reached. By knowing the typical times (e.g., looking at historical and dynamic data), the system may automatically predict a possible breach, and may take automatic actions such as returning the ticket to the user for more clarification, or requestion level two to make some assumptions to address the ticket before time runs out.

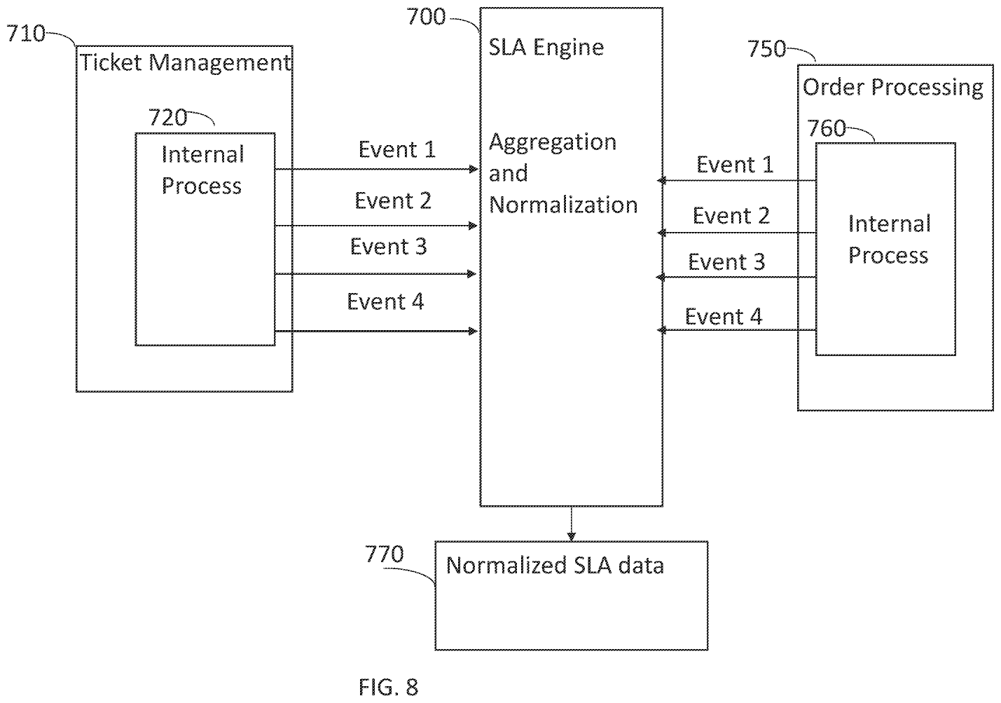

Turning now to FIG. 8, an aggregation of disparate systems is illustrated showing how differing systems with different steps and processes can be combined by the SLA engine into a uniform SLA metric (770).

A ticket management system (710) will have certain internal processes (720), which may comprise ticket escalation, response times, and severities among other things. The close rate of tickets, the response time and accuracy of tickets all affect the performance of tasks within this system and our ability to adhere to an SLA.

Another system for order processing (750) will include internal processes (760), which may in this case, comprise receiving orders, fulfilling orders, and shipping orders. The time to deliver the orders, the accuracy of the order being fulfilled, and the shipping speeds and costs may all be part of the performance metrics within the system (760).

These two different systems, while tracking completely different data can be aggregated by the SLA engine (700) to come up with an overall customer satisfaction metric (770) based on conformance to the individual SLAs.

More than simply a black and white SLA achieved or not achieved, we can also measure and monitor overall performance using the same metrics used in the SLA. For example, internal processes (720) for ticket management may give us 24 hours to respond to an initial ticket. The measurement should not simply be a yes or now, but rather, the response time for each ticket is measured. This is used to both forewarn of potential SLA breach, and to assess team performance, but it is also understood that the customer satisfaction index (770) will be higher if response times are shorter than longer (even if both are within the SLA).

Similarly, we may have a 1-week shipping target as part of the SLA for procurement but getting a delivery in 2 days will provide increased customer satisfaction. While both these events are separate and not comparable as apples to apples, the customer satisfaction index measurement and values can be shown, compared and aggregated.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for tracking telecommunications Service Level Agreement (SLA) compliance comprising:
a computer having a storage and a network connection and software executing on the computer comprising an SLA engine;
the SLA engine receiving indication of an order selected from the group consisting of: a telecommunications service, a telecommunications device order, technical support, shipping or combinations thereof;
the SLA engine further accessing one or more external systems which process the order, the one or more external systems accessed using the network, and the SLA engine identifies one or more events associated with the order based on data accessed at the one or more external systems, wherein the SLA engine obtains data concerning those one or more events from the one or more external systems and converts said data to a standardized format and stores the data in the standardized format in the storage;
the SLA engine further determining a maximum time for the order associated with the SLA and further determining from the one or more events when to start and stop a timer such that the timer tracks compliance with the maximum time required by the SLA associated with the order such that the SLA engine automatically starts and stops the timer, wherein the timer is stopped when the one or more events indicate the order is waiting on information from one or more users and the timer is started when the information from the one or more users is received;
said SLA engine generating an audit log from the data in the standardized format, the audit log indicating one or more reasons the timer stopped or started, the one or more reasons determined based on the one or more events.

2. The system of claim 1 wherein the audit log indicates one or more reasons for each time the timer stopped and started.

3. The system of claim 1 wherein the SLA engine further generates a communication for transmission to the user when the timer is stopped, the communication requesting the information the user, the audit log includes at least a portion of the communication.

4. The system of claim 1 wherein based on an amount of time remaining in the timer as compared to an expected amount of time to complete the order and alert is generated by the SLA engine if the comparison indicates a possibility of non-compliance with the SLA.

5. The system of claim 1 wherein the SLA engine determines from multiple previous orders an expected amount of time for one or more stages of the order and based on actual time for the one or more stages of the order, the storage is updated such that an expected amount of time for one or more stages of a future order is determined based on the multiple previous orders and the order.

6. The system of claim 5 wherein based on an amount of time remaining in the timer as compared to the expected amount of time to for one or more stages of the order an alert is generated by the SLA engine if the comparison indicates a possibility of non-compliance with the SLA.

7. A system for avoiding Service Level Agreement (SLA) penalties comprising:
a computer having a storage and a network connection and software executing on the computer comprising an SLA engine;
the SLA engine receiving indication of an order selected from the group consisting of: a telecommunications service, a telecommunications device order, technical support, shipping or combinations thereof;
the SLA engine monitoring a timer set based on an amount of time to complete the order according to the SLA engine;
the SLA engine tracks an amount of time remaining in the timer as compared to an amount of time that is expected to remain until completion of the order and if the comparison exceeds a threshold, the SLA engine generates an alert indicative of a SLA penalty or possibility thereof;
wherein the SLA engine determines an actual time to complete the one or more stages of the order and updates the storage with the actual time for the one or more stages such that the SLA engine is trained based on the actual time.

8. The system of claim 7 wherein the SLA engine is trained to determine the amount of time that is expected to remain for future orders based on the actual time of one or more past orders.

9. The system of claim 7 wherein the actual time of one or more past orders is an amount of time to complete one or more stages of that order.

10. The system of claim 9 further comprising the SLA engine further accessing one or more external systems which process the order, the one or more external systems accessed using the network, and the SLA engine identifies one or more events associated with the order based on data accessed at the one or more external systems, wherein the SLA engine obtains data concerning those one or more events from the one or more external systems and converts said data to a standardized format and stores the data in the standardized format in the storage.

11. The system of claim 10 wherein the amount of time to complete the order is a maximum time for the order associated with the SLA and the SLA engine further determining from the one or more events when to start and stop the timer such that the timer tracks compliance with the maximum time required by the SLA associated with the order such that the SLA engine automatically starts and stops the timer, wherein the timer is stopped when the one or more events indicate the order is waiting on information from one or more users and the timer is started when the information from the one or more users is received.

12. The system of claim 11 further comprising:
said SLA engine generating an audit log from the data in the standardized format, the audit log indicating one or more reasons the timer stopped or started, the one or more reasons determined based on the one or more events.

13. The system of claim 12 wherein the audit log indicates one or more reasons for each time the timer stopped and started.

14. A system for avoiding Service Level Agreement (SLA) penalties comprising:
a computer having a storage and a network connection and software executing on the computer comprising an SLA engine;
the SLA engine receiving indication of an order selected from the group consisting of: a telecommunications service, a telecommunications device order, technical support, shipping or combinations thereof;
the SLA engine monitoring a timer set based on an amount of time to complete the order according to the SLA;
the SLA engine determines one or more stages for the order and determines an expected amount of time for completion of each of the one or more stages based on order time history data stored in a storage accessible to the SLA engine.
the SLA engine tracks an amount of time remaining in the timer as compared to an amount of time that is expected to remain until completion of the order based on the expected time for each of the one or more stages and if the comparison exceeds a threshold, the SLA engine generates an alert indicative of a SLA penalty or possibility thereof;
wherein the SLA engine determines an actual time to complete the one or more stages of the order and updates the storage with the actual time for the one or more stages such that the SLA engine is trained based on the actual time.

15. The system of claim 14 further comprising the SLA engine further accessing one or more external systems which process the order, the one or more external systems accessed using the network, and the SLA engine identifies one or more events associated with the order based on data accessed at the one or more external systems, wherein the SLA engine obtains data concerning those one or more events from the one or more external systems and converts said data to a standardized format and stores the data in the standardized format in the storage.

16. The system of claim 15 wherein the amount of time to complete the order is a maximum time for the order associated with the SLA and the SLA engine further determining from the one or more events when to start and stop the timer such that the timer tracks compliance with the maximum time required by the SLA associated with the order such that the SLA engine automatically starts and stops the timer, wherein the timer is stopped when the one or more events indicate the order is waiting on information from one or more users and the timer is started when the information from the one or more users is received.

17. The system of claim 16 further comprising:
said SLA engine generating an audit log from the data in the standardized format, the audit log indicating one or more reasons the timer stopped or started, the one or more reasons determined based on the one or more events.

18. The system of claim 17 wherein the audit log indicates one or more reasons for each time the timer stopped and started.

19. The system of claim 14 wherein the SLA engine modifies the order at one or more external systems based on the alert to shorten an expected time for a next stage of the order.
